(19) United States
(12) Patent Application Publication
(10) Pub. No.: US 2024/0421977 A1
(43) Pub. Date: Dec. 19, 2024

(54) PROOF OF CONTENT EXISTENCE

(71) Applicants: Sony Group Corporation, Tokyo (JP); Sony Pictures Entertainment Inc., Culver City, CA (US)

(72) Inventor: Eric Diehl, Culver City, CA (US)

(21) Appl. No.: 18/210,000

(22) Filed: Jun. 14, 2023

(51) Int. Cl. H04L 9/06; G06F 21/62

(52) U.S. Cl. CPC H04L 9/0643; G06F 21/6218

(57) ABSTRACT

Proving a fixity of a catalog of documents to an auditor, including: splitting each document of the catalog of documents into a plurality of segments; calculating a fixity of each document by calculating a fixity of each segment and combining fixities of all segments, wherein the fixity of each segment is calculated by applying a fixity function on each segment; building and sending a manifest of fixities of the catalog of documents and the fixity function; randomly selecting a sample segment for each document; generating a challenge including sample fixities for a sample number of documents selected from the catalog of documents and sending the challenge to the prover; generating a response including sample segments retrieved from the sample number of documents; and verifying, for each sample segment in the response, that the fixity of each sample segment corresponds to the fixity in the manifest.

### BACKGROUND

### Field

The present disclosure relates to proving the existence content or documents, and more specifically, to proving a fixity of a catalog of documents.

### Background

When a content owner wishes to transfer ownership of a large catalog of confidential documents, including intellectual property contents (e.g., movies), a potential buyer will want the content owner to prove or demonstrate that the owner actually has access to the documents and that the integrity of the documents holds (i.e., the documents are indeed what the buyer is buying). Since the catalog is a large part of the valuation, the catalog is backed up by archives. In some cases, it is essential to prove to the potential buyer (e.g., a financial institution) that the archived documents are accessible and that their integrity holds (accessibility and integrity together may be referred to as “fixity”).

The current solution is to provide controlled access to the catalog to auditors. Thus, auditors have access to confidential and sensitive documents. This process requires the handling and inspection of a large number of documents (e.g., in the case of movies, the size of one master may exceed several Tera bytes). This process also requires granting access to the auditors to confidential information with a risk of a leak. Therefore, proving or inspecting a large catalog of confidential documents may be costly and time consuming, since the proof/inspection may involve a large number of documents. There may also be security issues with confidentiality of the documents, since the auditor or potential buyer may have to have full access to the documents to verify the accessibility and the integrity.

### SUMMARY

The present disclosure implements techniques for granting access to the auditors to a small subset of the documents for inspection, where the auditor is allowed to pick the small subset to inspect the fixity of the documents.

In one implementation, a method for proving a fixity of a catalog of documents to an auditor is disclosed. The method includes: splitting each document of the catalog of documents into a plurality of segments, at a prover; calculating, at a prover, a fixity of each document by calculating a fixity of each segment and combining fixities of all segments, wherein the fixity of each segment is calculated by applying a fixity function on each segment; building and sending a manifest of fixities of the catalog of documents and the fixity function to the auditor; randomly selecting, at the auditor, a sample segment for each document; generating, at the auditor, a challenge including sample fixities for a sample number of documents selected from the catalog of documents and sending the challenge to the prover; generating, at the prover, a response including sample segments retrieved from the sample number of documents; and verifying, at the auditor, for each sample segment in the response, that the fixity of each sample segment corresponds to the fixity in the manifest.

In another implementation, a system for proving a fixity of a catalog of documents includes a prover and an auditor.

The prover splits each document of the catalog of documents into a plurality of segments. The prover also calculates a fixity of each document by calculating a fixity of each segment and combining fixities of all segments, wherein the fixity of each segment is calculated by applying a fixity function on each segment. The prover further builds and sends a manifest of fixities of the catalog of documents and the fixity function.

The auditor receives the manifest of fixities and selects random segments. The auditor also generates a challenge including sample fixities for a sample number of documents selected from the catalog of documents and sending the challenge to the prover, wherein the prover receives the challenge, generates, and sends a response including sample segments retrieved from the sample number of documents. The auditor further verifies, for each sample segment in the response, that the fixity of each sample segment corresponds to the fixity in the manifest.

In yet another implementation, a non-transitory computer-readable storage medium storing a computer program to prove a fixity of a catalog of documents includes executable instructions that cause a computer to: split each document of the catalog of documents into a plurality of segments; calculate a fixity of each document by calculating a fixity of each segment and combining fixities of all segments, wherein the fixity of each segment is calculated by applying a fixity function on each segment; build and send a manifest of fixities of the catalog of documents and the fixity function; randomly select a sample segment for each document; generate a challenge including sample fixities for a sample number of documents selected from the catalog of documents and sending the challenge to the prover; generate a response including sample segments retrieved from the sample number of documents; and verify, for each sample segment in the response, that the fixity of each sample segment corresponds to the fixity in the manifest.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram of a process for proving the fixity of documents to an auditor in accordance with one implementation of the present disclosure;

FIG. 2 is a block diagram of a system for proving the fixity of documents to an auditor in accordance with one implementation of the present disclosure;

FIG. 3A is a representation of a computer system and a user in accordance with an implementation of the present disclosure; and

FIG. 3B is a functional block diagram illustrating the computer system hosting the proof of fixity application in accordance with an implementation of the present disclosure.

### DETAILED DESCRIPTION

As described above, proving, or inspecting a large catalog of confidential documents may be costly and time consuming, and may also involve security issues with confidentiality of the documents. To address the issues with the conventional proof of content, certain implementations of the present disclosure provide for apparatus and methods to implement techniques for granting access to the auditors to a small subset of the documents for inspection, where the auditor is allowed to pick the small subset to inspect the fixity of the documents.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

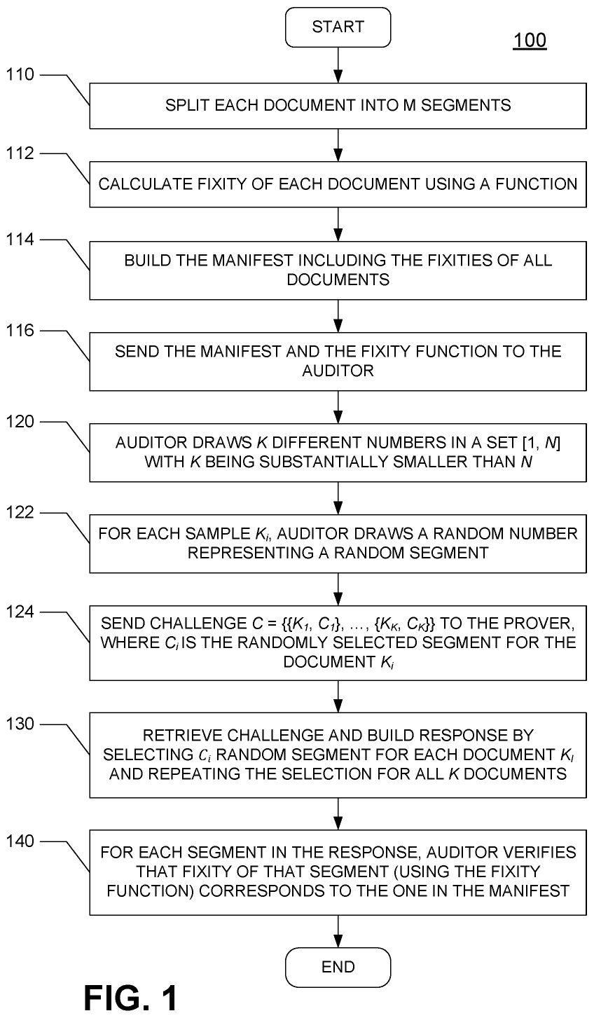

FIG. 1 is a flow diagram of a process 100 for proving the fixity of documents to an auditor in accordance with one implementation of the present disclosure. In one implementation, the auditor is a representative agent of a buyer of the documents or agent's computer. In one implementation, the proof of the fixity is performed by a prover (e.g., a seller of the documents or seller's computer).

In one implementation, the fixity (F) (i.e., an information demonstrating that document D has not been impaired) of a document (D) is calculated using function f with the following condition:

$$∀ D \neq {D}^{′} ⇒ f ( D ) \neq f ( {D}^{′} ) , \qquad [ 1 ]$$

which means that if document D is different from document D′, then fixity of D is different from fixity of D′.

In one implementation, the fixity function f is a cryptographic hash function including secure hashing algorithm 256 (SHA256), SHA512, or SHA3. These functions are secure, and are considered one-way functions (i.e., for any arbitrary value of fixity it is computationally infeasible to find data that produced the corresponding fixity). Thus, cryptographic hash functions provide an acceptable approximation of Equation [1].

In the illustrated implementation of FIG. 1, each document (Dₙ) is split into m segments Dₙ¹, Dₙ², . . . Dₙ^{m}, at block 110. Thus, Dₙ=Dₙ¹∥Dₙ²∥ . . . ∥Dₙ^{m}, where ∥ represents the concatenation operator. In one implementation, a catalog of documents may include N documents (e.g., N=10,000), while each document (Dₙ) is split into m segments (e.g., m=1,024). Therefore, the fixity (Fₙ) of each document (Dₙ) may include the m-tuplet {Fₙ¹, Fₙ², . . . Fₙ^{m}}.

In the illustrated implementation of FIG. 1, the prover then calculates the fixity (Fₙ) of each document (Dₙ), at block 112, using Equation [2] shown below:

$${F}_{n}^{i} = f ( {D}_{n}^{i} ) , \qquad [ 2 ]$$

where ƒ is the fixity function,
   n is index for the document, and
   i is index for segment within the document.
      The prover then builds, at block 114, the manifest M={F₁, F₂, . . . F_{N}}, which includes the fixities of N documents. In one implementation, the manifest M also holds the titles of the documents, and may include descriptions of the documents. Further, the prover may cryptographically sign the manifest M.

In the illustrated implementation of FIG. 1, the prover desires to prove to the auditor that it has access to the N documents and that the documents have not been impaired (i.e., the fixity). Toward this goal, the prover sends the manifest M and the fixity function f to the auditor, at block 116.

In one implementation, the auditor then draws K different numbers K₁, K₂, . . . K_{K} in the set [1, N], at block 120, with K (i.e., the sample size) being far smaller than N (i.e., the number of documents in the catalog). In one example, N is 10,000 and K is 100 (i.e., K is at least two orders of magnitude smaller than N). For each sample Kᵢ, in one implementation, the auditor draws and provides to the prover one random value Cᵢ in the set [1, m], at block 122, where m is the number of segments of the document Dₖ_{ᵢ} and Cᵢ is the random value drawn by the auditor. Thus, in blocks 120 and 122, the auditor generates challenge C (by randomly selecting K sample documents and selecting a random segment Cᵢ for each sample document Kᵢ), where C={{K₁, C₁}, . . . , {K_{K}, C_{K}}}.

In response to the challenge, in one implementation, the prover: (a) retrieves the K segments such as ∀i∈[1, K], Sᵢ=D_{K}_{ᵢ}^{C}^{ᵢ}; (b) builds the challenge's response such as R={D₁, . . . , D_{K}}; and (c) provides the response to the auditor, at block 130. That is, in one implementation, the challenge's response is built by selecting random segment Cᵢ for each document Kᵢ and repeating the selection for all K documents.

In one implementation, for each segment in the challenge's response, the auditor verifies, at block 140, that the fixity (F_{K}_{ᵢ}^{C}^{ᵢ}) of that segment corresponds to the one in the manifest (M), i.e., ∀i∈[1, K], ƒ(Sᵢ)=F_{K}_{ᵢ}^{C}^{ᵢ}. The fixity of each segment is calculated by the auditor by applying the fixity function on the received segment. If all the verifications are valid, and K is large enough, the auditor has a reasonable assurance that the prover has all N documents in possession and that the documents are not impaired. Furthermore, the prover can be assured that auditor did not get enough confidential information to be a severe security risk. In the illustrated implementation of FIG. 1, blocks 110-116 and 130 are performed by the prover, while blocks 120-124 and 140 are performed by the auditor.

In an alternative implementation for the challenge, the auditor sends two sets of challenges to the prover: (a) the request for K segments; and (b) the request for K′ complete documents with K′ being substantially smaller than K (e.g., K=100, while K′=2). In this implementation, the first verification is fully automated, while the second verification may be a human checking the document and that it corresponds to the title in the manifest.

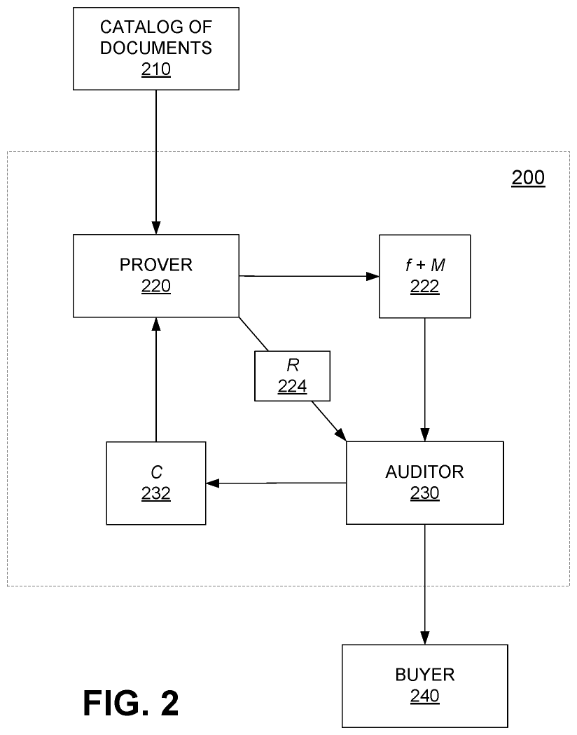

FIG. 2 is a block diagram of a system 200 for proving the fixity of documents to an auditor in accordance with one implementation of the present disclosure. In the illustrated implementation of FIG. 2, the system 200 includes a prover 220, fixity function and manifest 222, a response 224, an auditor 230, and a challenge 232. In one implementation, the auditor 230 is a representative agent (or agent's computer) of a buyer 240. In one implementation, the proof of the fixity of the documents is performed by the prover (e.g., a seller or seller's computer) 220. In one implementation, the blocks 220 and 230 of the system 200 are configured entirely with hardware including one or more digital signal processors (DSPs), general purpose microprocessors, application specific integrated circuits (ASICs), field programmable logic arrays (FPGAs), or other equivalent integrated or discrete logic circuitry.

In one implementation, the fixity (F) (i.e., an information demonstrating that document D has not been impaired) of a document (D) is calculated using function f with the following condition ∀D≠D′⇒ƒ(D)≠ƒ(D′) as shown in Equation [1], which means that if document D is different from document D′, then fixity of D is different from fixity of D′. In one implementation, the fixity function f is a cryptographic hash function including secure hashing algorithm 256 (SHA256), SHA512, or SHA3. These functions are secure, and are considered one-way functions (i.e., for any arbitrary value of fixity it is computationally infeasible to find data that produced the corresponding fixity). Thus, cryptographic hash functions provide an acceptable approximation of Equation [1].

In the illustrated implementation of FIG. 2, the prover 220 accesses a catalog of documents 210 and splits each document (D) in the catalog 210 into m segments as Dₙ¹, Dₙ², . . . Dₙ^{m}. Thus, Dₙ=Dₙ¹∥Dₙ²∥ . . . ∥Dₙ^{m}, where ∥ represents the concatenation operator. In one example, the catalog of documents 210 may include N documents (e.g., N=10,000), while each document (Dₙ) is split into m segments (e.g., m=1,024). Therefore, the fixity (Fₙ) of each document (Dₙ) may include the m-tuplet {Fₙ¹, Fₙ², . . . Fₙ^{m}}.

In the illustrated implementation of FIG. 2, the prover then calculates the fixity (Fₙ) of each document (Dₙ) using Equation [2] (Fₙⁱ=ƒ(Dₙⁱ)) shown above. The prover 220 then builds the manifest M={F₁, F₂, . . . F_{N}}, which includes the fixities of N documents. In one implementation, the manifest M also holds the titles of the documents, and may include descriptions of the documents. Further, the prover 220 may cryptographically sign the manifest M.

In the illustrated implementation of FIG. 2, the prover 220 desires to prove to the auditor 230 that it has access to the N documents and that the documents have not been impaired (i.e., the fixity). Toward this goal, the prover 220 sends the manifest M and the fixity function f 222 to the auditor 230.

In one implementation, the auditor 230 then draws K different numbers K₁, K₂, . . . K_{K} in the set [1, N] with K (i.e., the sample size) being far smaller than N (i.e., the number of documents in the catalog). In one example, N is 10,000 and K is 100. For each sample Kᵢ, in one implementation, the auditor 230 draws and sends to the prover 220 one random value Cᵢ in the set [1, m], where m is the number of segments of the document Dₖ_{ᵢ} and Cᵢ is the random value drawn by the auditor 230. Thus, the auditor generates challenge C 232 (by generating K sample documents and Cᵢ random segment for each sample document Kᵢ), where C={{K₁, C₁}, . . . , {K_{K}, C_{K}}}.

In response to the challenge 232, in one implementation, the prover 220: (a) retrieves the K segments such as ∀i∈[1, K], Sᵢ=D_{K}_{ᵢ}^{C}^{ᵢ}; (b) builds the challenge's response 224 such as R={D₁, . . . , D_{K}}; and (c) provides the response to the auditor 230. That is, in one implementation, the challenge's response 224 is built by selecting Cᵢ random segment for each document Kᵢ and repeating the selection for all K documents.

In one implementation, for each segment in the challenge's response 224, the auditor 230 verifies that the fixity (FC) of that segment corresponds to the one in the manifest (M), i.e., ∀i∈[1, K], ƒ(Sᵢ)=F_{K}_{ᵢ}^{C}^{ᵢ}. The fixity of each segment is calculated by the auditor applying the fixity function on the received segment. If all the verifications are valid, and K is large enough, the auditor 230 notifies the buyer 240 that the prover 220 has all N documents in possession and that the documents are not impaired.

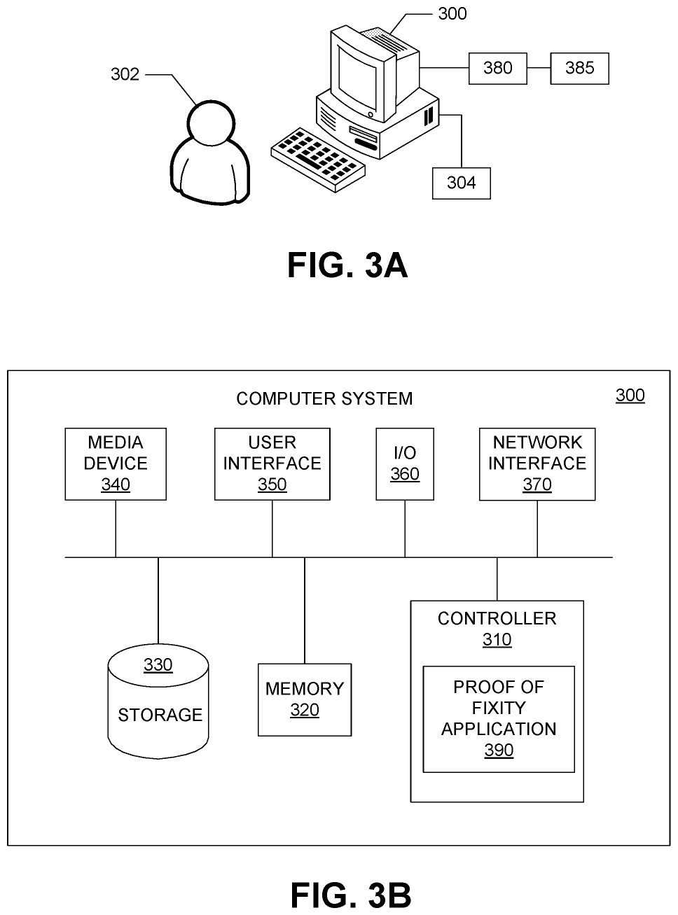

FIG. 3A is a representation of a computer system 300 and a user 302 in accordance with an implementation of the present disclosure. The user 302 uses the computer system 300 to implement a proof of fixity application 390 for proving the fixity of documents to an auditor with respect to the process 100 of FIG. 1 and the system 200 of FIG. 2.

The computer system 300 stores and executes the proof of fixity application 390 of FIG. 3B. In addition, the computer system 300 may be in communication with a software program 304. Software program 304 may include the software code for the proof of fixity application 390. Software program 304 may be loaded on an external medium such as a CD, DVD, or a storage drive, as will be explained further below.

Furthermore, the computer system 300 may be connected to a network 380. The network 380 can be connected in various different architectures, for example, client-server architecture, a Peer-to-Peer network architecture, or other type of architectures. For example, network 380 can be in communication with a server 385 that coordinates engines and data used within the proof of fixity application 390. Also, the network can be different types of networks. For example, the network 380 can be the Internet, a Local Area Network or any variations of Local Area Network, a Wide Area Network, a Metropolitan Area Network, an Intranet or Extranet, or a wireless network.

FIG. 3B is a functional block diagram illustrating the computer system 300 hosting the proof of fixity application 390 in accordance with an implementation of the present disclosure. A controller 310 is a programmable processor and controls the operation of the computer system 300 and its components. The controller 310 loads instructions (e.g., in the form of a computer program) from the memory 320 or an embedded controller memory (not shown) and executes these instructions to control the system, such as to provide the data processing. In its execution, the controller 310 provides the proof of fixity application 390 with a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data either temporarily or for long periods of time for use by the other components of the computer system 300. For example, storage 330 stores data used by the proof of fixity application 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user 302. In one implementation, the user interface 350 includes a keyboard, a mouse, audio speakers, and a display. In another implementation, the user interface 350 also includes a headset worn by the user and used to collect eye movements as user inputs. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

In one particular implementation, a method for proving a fixity of a catalog of documents to an auditor is disclosed. The method includes: splitting each document of the catalog of documents into a plurality of segments, at a prover; calculating, at a prover, a fixity of each document by calculating a fixity of each segment and combining fixities of all segments, wherein the fixity of each segment is calculated by applying a fixity function on each segment; building and sending a manifest of fixities of the catalog of documents and the fixity function to the auditor; randomly selecting, at the auditor, a sample segment for each document; generating, at the auditor, a challenge including sample fixities for a sample number of documents selected from the catalog of documents and sending the challenge to the prover; generating, at the prover, a response including sample segments retrieved from the sample number of documents; and verifying, at the auditor, for each sample segment in the response, that the fixity of each sample segment corresponds to the fixity in the manifest.

In one implementation, the fixity function is a cryptographic hash function including one of a secure hashing algorithm 256 (SHA256), SHA512, or SHA3. In one implementation, the sample number of documents is at least two orders of magnitude smaller than a number of documents in the catalog of documents. In one implementation, the manifest includes titles and descriptions of the catalog of documents. In one implementation, the prover cryptographically signs the manifest. In one implementation, the fixity of each sample segment is calculated by the auditor applying the fixity function on each sample segment in the response. In one implementation, the auditor is a representative agent of a buyer of the catalog of documents. In one implementation, the method further includes notifying the buyer that the catalog of documents in possession of the prover and that the documents are not impaired, when all verifications are valid. In one implementation, the challenge further includes a request for a second number of complete documents, wherein the second number is substantially smaller than the sample number.

In another particular implementation, a system for proving a fixity of a catalog of documents includes a prover and an auditor. The prover splits each document of the catalog of documents into a plurality of segments. The prover also calculates a fixity of each document by calculating a fixity of each segment and combining fixities of all segments, wherein the fixity of each segment is calculated by applying a fixity function on each segment. The prover further builds and sends a manifest of fixities of the catalog of documents and the fixity function. The auditor receives the manifest of fixities and selects a sample segment for each document. The auditor also generates a challenge including sample fixities for a sample number of documents selected from the catalog of documents and sending the challenge to the prover, wherein the prover receives the challenge, generates and sends a response including sample segments retrieved from the sample number of documents. The auditor further verifies, for each sample segment in the response, that the fixity of each sample segment corresponds to the fixity in the manifest.

In one implementation, the fixity function is a cryptographic hash function including one of a secure hashing algorithm 256 (SHA256), SHA512, or SHA3. In one implementation, the sample number of documents is at least two orders of magnitude smaller than a number of documents in the catalog of documents. In one implementation, the manifest includes titles and descriptions of the catalog of documents. In one implementation, the prover cryptographically signs the manifest. In one implementation, the fixity of each sample segment is calculated by the auditor applying the fixity function on each sample segment in the response. In one implementation, the auditor is a representative agent of a buyer of the catalog of documents. In one implementation, the challenge further includes a request for a second number of complete documents, wherein the second number is substantially smaller than the sample number.

In yet another particular implementation, a non-transitory computer-readable storage medium storing a computer program to prove a fixity of a catalog of documents includes executable instructions that cause a computer to: split each document of the catalog of documents into a plurality of segments; calculate a fixity of each document by calculating a fixity of each segment and combining fixities of all segments, wherein the fixity of each segment is calculated by applying a fixity function on each segment; build and send a manifest of fixities of the catalog of documents and the fixity function; randomly select a sample segment for each document; generate a challenge including sample fixities for a sample number of documents selected from the catalog of documents and sending the challenge to the prover; generate a response including sample segments retrieved from the sample number of documents; and verify, for each sample segment in the response, that the fixity of each sample segment corresponds to the fixity in the manifest.

In one implementation, the fixity function is a cryptographic hash function including one of a secure hashing algorithm 256 (SHA256), SHA512, or SHA3. In one implementation, the sample number of documents is at least two orders of magnitude smaller than a number of documents in the catalog of documents.

The description herein of the disclosed implementations is provided to enable any person skilled in the art to make or use the present disclosure. Numerous modifications to these implementations would be readily apparent to those skilled in the art, and the principles defined herein can be applied to other implementations without departing from the spirit or scope of the present disclosure. Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for proving a fixity of a catalog of documents to an auditor, the method comprising:
splitting each document of the catalog of documents into a plurality of segments, at a prover;
calculating, at a prover, a fixity of each document by calculating a fixity of each segment and combining fixities of all segments, wherein the fixity of each segment is calculated by applying a fixity function on each segment;
building and sending a manifest of fixities of the catalog of documents and the fixity function to the auditor;
receiving the manifest and randomly selecting, at the auditor, a sample segment for each document;
generating, at the auditor, a challenge including sample fixities for a sample number of documents selected from the catalog of documents and sending the challenge to the prover;
generating, at the prover, a response including sample segments retrieved from the sample number of documents; and
verifying, at the auditor, for each sample segment in the response, that the fixity of each sample segment corresponds to the fixity in the manifest.

2. The method of claim 1, wherein the fixity function is a cryptographic hash function including one of a secure hashing algorithm 256 (SHA256), SHA512, or SHA3.

3. The method of claim 1, wherein the sample number of documents is at least two orders of magnitude smaller than a number of documents in the catalog of documents.

4. The method of claim 1, wherein the manifest includes titles and descriptions of the catalog of documents.

5. The method of claim 1, wherein the prover cryptographically signs the manifest.

6. The method of claim 1, wherein the fixity of each sample segment is calculated by the auditor applying the fixity function on each sample segment in the response.

7. The method of claim 1, wherein the auditor is a representative agent of a buyer of the catalog of documents.

8. The method of claim 7, further comprising
notifying the buyer that the catalog of documents in possession of the prover and that the documents are not impaired, when all verifications are valid.

9. The method of claim 1, wherein the challenge further includes a request for a second number of complete documents, wherein the second number is substantially smaller than the sample number.

10. A system for proving a fixity of a catalog of documents to an auditor, the system comprising:
a prover to split each document of the catalog of documents into a plurality of segments, the prover to calculate a fixity of each document by calculating a fixity of each segment and combining fixities of all segments,
wherein the fixity of each segment is calculated by applying a fixity function on each segment,
the prover to build and send a manifest of fixities of the catalog of documents and the fixity function; and
an auditor to receive the manifest of fixities and randomly select a sample segment for each document, the auditor to generate a challenge including sample fixities for a sample number of documents selected from the catalog of documents and sending the challenge to the prover,
wherein the prover receives the challenge, generates and sends a response including sample segments retrieved from the sample number of documents,
the auditor to verify for each sample segment in the response, that the fixity of each sample segment corresponds to the fixity in the manifest.

11. The system of claim 10, wherein the fixity function is a cryptographic hash function including one of a secure hashing algorithm 256 (SHA256), SHA512, or SHA3.

12. The system of claim 10, wherein the sample number of documents is at least two orders of magnitude smaller than a number of documents in the catalog of documents.

13. The system of claim 10, wherein the manifest includes titles and descriptions of the catalog of documents.

14. The system of claim 10, wherein the prover cryptographically signs the manifest.

15. The system of claim 10, wherein the fixity of each sample segment is calculated by the auditor applying the fixity function on each sample segment in the response.

16. The system of claim 10, wherein the auditor is a representative agent of a buyer of the catalog of documents.

17. The system of claim 10, wherein the challenge further includes a request for a second number of complete documents, wherein the second number is substantially smaller than the sample number.

18. A non-transitory computer-readable storage medium storing a computer program to prove a fixity of a catalog of documents, the computer program comprising executable instructions that cause a computer to:
split each document of the catalog of documents into a plurality of segments;
calculate a fixity of each document by calculating a fixity of each segment and combining fixities of all segments, wherein the fixity of each segment is calculated by applying a fixity function on each segment;
build and send a manifest of fixities of the catalog of documents and the fixity function;
randomly select a sample segment for each document;
generate a challenge including sample fixities for a sample number of documents selected from the catalog of documents and sending the challenge to the prover;
generate a response including sample segments retrieved from the sample number of documents; and
verify, for each sample segment in the response, that the fixity of each sample segment corresponds to the fixity in the manifest.

19. The non-transitory computer-readable storage medium of claim 18, wherein the fixity function is a cryptographic hash function including one of a secure hashing algorithm 256 (SHA256), SHA512, or SHA3.

20. The non-transitory computer-readable storage medium of claim 18, wherein the sample number of documents is at least two orders of magnitude smaller than a number of documents in the catalog of documents.
